(19) United States
(12) Patent Application Publication
(10) Pub. No.: US 2004/0105005 A1
(43) Pub. Date: Jun. 3, 2004

(54) Networked camera system and a monitoring method thereof

(75) Inventors: Takayuki Yamamoto, Yokohama (JP); Shigeto Oeda, Fujisawa (JP); Ichiro Ote, Chigasaki (JP)

Correspondence Address: McDERMOTT, WILL & EMERY, 600 13th Street, N.W., Washington, DC, 20005-3096, US

(73) Assignee: HITACHI, LTD.

(21) Appl. No.: 10/651,078

(22) Filed: Aug. 29, 2003

(30) Foreign Application Priority Data
Nov. 14, 2002 (JP) 2002-330213

(51) Int. Cl. H04N 7/18

(52) U.S. Cl. 348/159

(57) ABSTRACT

In a networked camera system and a monitoring method thereof, each networked camera has camera information for discriminating the respective apparatus, and an index server, registering the camera information of the respective networked cameras therein, makes search for connection information to the networked camera corresponding thereto, responding to a monitoring target required from the networked monitor, upon the basis of the camera information registered, thereby transmitting it to the networked monitor. The networked monitor connects to a predetermined networked camera upon the basis of the connection information, so as to request a picked-up picture therefrom, thereby displaying the picture transmitted from the networked camera. The networked camera and the networked monitor make transmission of the picked-up picture through the mutual connection therebetween, but without passing through the index server. Therefore, the networked camera system and a monitoring method thereof can be provided, in which everybody can set up the camera easily, so as to display a picture desired with easy operation, and further is high in immediacy and stability thereof.

### BACKGROUND OF THE INVENTION

1. Field of the Invention

The present invention relates to a networked camera system, in which networked monitoring cameras and observation monitors are connected through a network, and it also relates to a monitoring method thereof, as well as, an index server, a networked camera and a networked monitor.

2. Description of the Related Art

Conventionally, networked monitoring cameras are widely used, ordinarily, for example, for the purpose of protection against crimes, observation of traffic condition, etc. As such, there is already known a networked camera system, in which monitoring cameras, image receiver terminals, a data base or a server for storing therein position information of the cameras, etc., and a base station for providing information, and so on, are connected with, respectively, through a network, for example, in Japanese Patent Laying-Open No. 2001-155289 (2001) <hereinafter, called by a Patent Document 1>. The invention disclosed in this Patent Document is a system enabling to obtain real time image information, such as, the detailed traffic information, etc.

### BRIEF SUMMARY OF THE INVENTION

However, with such the system as is disclosed in the Patent Document 1, the pictures or images from the networked cameras are monitored through the database for storing the information, such as, camera information, or the like, the server for managing the information, and/or the base station for providing the information. For this reason, the server and/or the base station bear considerable heavy load thereon, in particular, on image transmission of the pictures from the networked cameras, so as to deal with connection requirements for monitoring, etc., for example, and therefore the information to be dealt with in the server and/or the base station comes to be massive in an amount thereof, as the number of users and/or the number of the networked cameras increase up. As a result of this, the processing capacity is lowered, remarkably; therefore it is impossible to transmit the picture or image in real-time. In the worst case, it can be considered that the server and/or the base station crash down. If so, it is insufficient for the monitoring system, by which an urgent case must be considered, such as, when the crime is committed, for example. Also, it may be possible to dissolve such the problem, for example, by enhancing the processing capacity or increasing the number of the servers, etc., however it takes costs, too much. Also, there is no description about new registration of a camera into the server and/or the base station, therefore it cannot be said that the system disclosed therein can be used, easily for everyone through an open network.

An object, according to the present invention, being achieved by taking the problems of the conventional art mentioned above into the consideration, is to provide a monitoring system of low cost.

For dissolving such the problems mentioned above, according to the present invention, there is provided a networked camera system, comprising: a plural number of networked cameras; a networked monitor; an index server; and a network, wherein said cameras, said monitor and said server are connected, respectively, through said network, for monitoring a picture transmitted from said networked camera on said networked monitor, and wherein each of said networked cameras comprises: a memory for memorizing networked camera information for discriminating the networked cameras, respectively; an image pickup element for picking up the picture; and a transmitter for transmitting said picture picked-up to said networked monitor upon receipt of a connection request from said networked monitor, said index server comprises: a register for registering the networked camera information of each of said networked cameras; a search unit for searching connection information to the networked camera corresponding thereto, depending upon a monitoring object transmitted from said networked monitor, with using the networked camera information registered in said register; and a transmitter for transmitting said connection information searched to said networked monitor, said networked monitor comprises: a transmitter for transmitting said monitoring object to said index server; a connection request unit for connecting to a predetermined networked camera and requesting the picture picked-up, upon basis of the connection information transmitted from said index server; and a display for displaying the picture transmitted from said networked camera thereon, and said networked camera and said networked monitor transmits the picture picked-up through connection to each other. With applying such the structure therein, URL or the like, being the networked camera information of the networked cameras, and also the position information thereof are stored in the index server, with relating to each other. With this, it is possible to manage the networked camera information, integrally or totally, and also to make the search for the networked camera, on which a user desires to monitor, easy. Also, since the networked camera and the networked monitor conduct the transmission of the picture through the mutual connection therebetween, without passing through the index server, therefore the index server bears no load thereupon, thereby achieving the stability and the immediacy thereof.

Also, according to the present invention, there is also provided a networked camera system, comprising: a plural number of networked cameras; a networked monitor; an index server; and a network, wherein said cameras, said monitor and said server are connected, respectively, through said network, for monitoring a picture transmitted from said networked camera on said networked monitor, and wherein each of said networked cameras has networked camera information for discriminating said networked cameras, respectively, and networked camera information of other networked camera, and comprises: an image pickup element for picking up the picture; a first search unit for searching connection information of requiring monitor from the networked camera information of said other networked camera upon receipt of a request of said networked monitor; and a transmitter for transmitting said picked-up monitor picture and the connection information searched out by means of said first search unit, to said networked monitor, upon receipt of a request from said networked monitor, said index server comprises: a register for registering the networked camera information of each of said networked cameras; a second search unit for searching connection information to the networked camera corresponding to the request of said networked monitor from said networked camera information registered; and a transmitter for transmitting said connection information searched to said networked monitor, said networked monitor comprises: a transmitter for transmitting said monitoring object to said index server; a connection request unit for connecting to a networked camera, to which a use requires monitoring, from the connection information transmitted from said index server or the connection information transmitted from said networked camera, thereby requesting a monitor picture thereto; a controller unit for controlling destination of connection by said connection request unit; and a display for displaying the monitor picture transmitted from said networked camera thereon, and said networked camera and said networked monitor transmits the picture picked-up through connection to each other, and exchange to the networked camera requiring the monitoring is conducted by said first search unit and said transmitter of said networked camera. Thus, the second search unit mentioned above has such the structure, that it searches out the connection information to the networked camera upon the basis of the monitoring target transmitted from said networked monitor, and that said networked monitor receives the monitor picture transmitted from said networked camera without passing through said index server. With applying such the structure therein, URL or the like, being the networked camera information of the networked cameras, and also the position information thereof are stored in the index server, with relating to each other. With this, it is possible to manage the networked camera information, integrally or totally, and also to make the search for the networked camera, on which a user desires to monitor, easy. Also, since the networked camera and the networked monitor conduct the transmission of the picture through the mutual connection therebetween, without passing through the index server, therefore the index server bears no load thereupon, thereby achieving the stability and the immediacy thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an embodiment of a networked camera system, according to the present invention;

FIG. 2 is a block diagram for showing an example of the structure of a networked camera shown in FIG. 1;

FIG. 3 is a block diagram for showing an example of the structure of an index server shown in FIG. 1;

FIG. 4 is a block diagram for showing an example of the structure of a networked monitor shown in FIG. 1;

FIG. 5 is a block diagram for showing an example of the structure of a storage shown in FIG. 1;

FIG. 6 is a flowchart for showing a basic operation of the system shown in FIG. 1;

FIG. 7 is a view for showing an example of networked camera information shown in FIG. 6;

FIG. 8 is a view for showing an example of connection information shown in FIG. 6;

FIG. 9 shows a flowchart for showing other operation with using the system shown in FIG. 1;

FIG. 10 is a block diagram for showing the networked camera system, according to other embodiment of the present invention;

FIG. 11 is a flowchart for showing an operation of the system shown in FIG. 10;

FIG. 12 is a view for showing an example of a monitoring contract, with using the system shown in FIG. 10;

FIG. 13 is a view for showing an example, where an object of monitoring is caught by means of a sensor of the networked camera;

FIG. 14 is a view for showing an example of information of the object of monitoring;

FIG. 15 is a view for showing an example of image processing on the networked camera picture;

FIG. 16 is a view for showing a linkage monitoring, with using a plural number of networked cameras;

FIG. 17 is an example of image on a primary monitor of the linkage monitoring;

FIG. 18 is a view for showing a method for producing a plane picture from a fish-eye lens;

FIG. 19 is a view for showing a mapping of locations of the networked cameras on a map;

FIG. 20 is a view for showing an example of an early-warning monitoring system, for suspicious persons;

FIG. 21 shows a flowchart for showing processing, when producing a record and/or an album with using the pictures, in the present networked camera system;

FIG. 22 shows a flowchart for showing processing, when making communication by using the pictures, in the present networked camera system;

FIG. 23 is a view for showing an example of accounting in the present networked camera system;

FIG. 24 is a view for showing an example, where a neighbor information holder device is attached onto the network camera;

FIG. 25 is a flowchart for showing a basic flow, in particular, in a case when the neighbor information holder device is attached onto the network camera;

FIG. 26 shows an example of an information table held in the neighbor information holder device; and

FIG. 27 also shows an example of the information table held in the neighbor information holder device.

### DETAILED DESCRIPTION OF THE INVENTION

Hereinafter, embodiments according to the present invention will be fully explained by referring to the attached drawings.

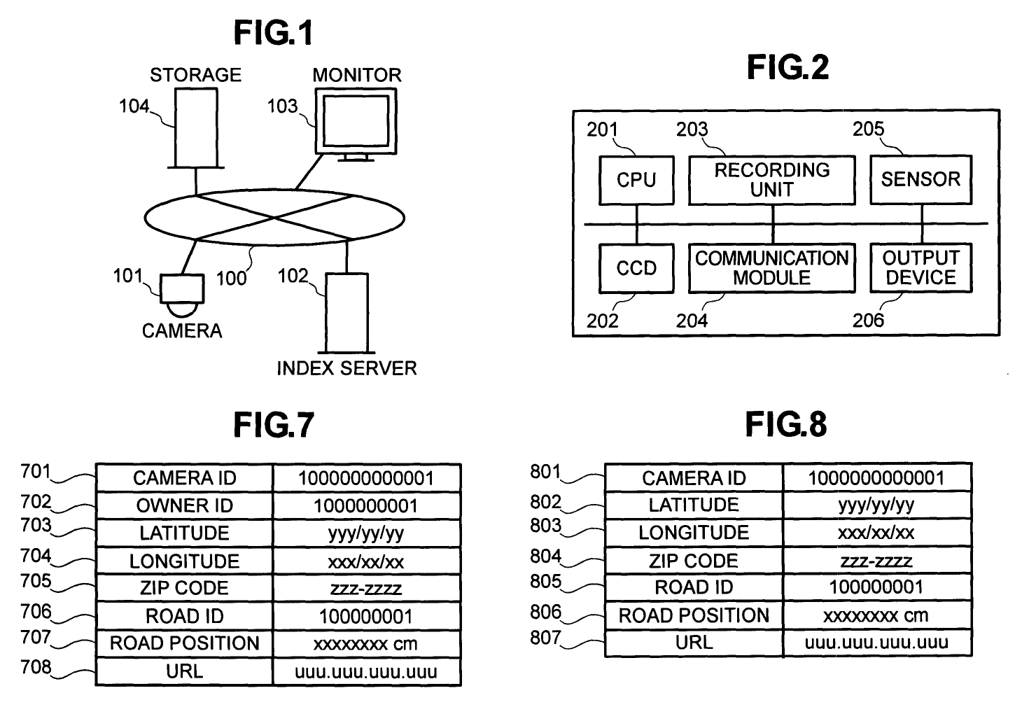

FIG. 1 is a view for showing an embodiment of a networked camera system according to the present invention. A reference numeral 100 indicates a network, 101 a networked camera, 103 a networked observation monitor for displaying an image or picture from the networked camera, and 104 a storage for storing video/audio of the networked camera. A reference numeral 102 indicates an index server for registering connection information of the networked camera, the networked monitor, and/or the storage on the network, thereby conducting search on each terminal.

FIG. 2 is the structure view of the networked camera 101 shown in FIG. 1. A reference numeral 201 depicts a CPU (Central Processing Unit), 202 a CCD (Charge Coupled Device) and a microphone. A reference numeral 203 depicts a recording unit, which is constructed with a RAM (Random Access Memory), a ROM (Read Only Memory), and a hard disk, etc., and it is used for recording therein video/audio, temporary, recording of data, and execution of programs. A reference numeral 204 depicts a communication interface for making a connection with the network. A reference numeral 205 depicts a sensor for use of detection of an object, and it detects that the object exists in the vicinity or neighbor of the sensor, or that the object is moving, or that the object radiates a specific radio wave therefrom, by detecting the radio wave of a specific frequency, a specific signal, and/or radio waves of strength being equal or greater than a certain value. However, the detecting method thereof should not be restricted only to those mentioned above. A reference numeral 206 depicts a display apparatus and a speaker, which displays a picture thereon and/or outputs a visual signal, such as, an electric bulb and so on, and also an alarming sound therefrom. The networked camera is able to take, not only the moving picture, but also a static picture, by means of the CCD, thereby to transmit them.

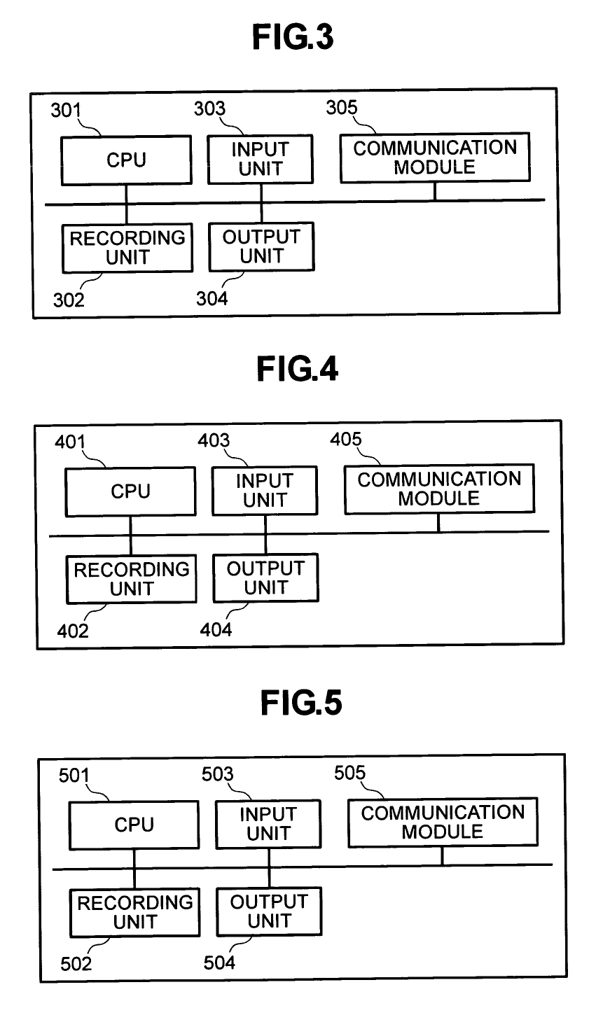

FIG. 3 is the structure view of the index server 102 shown in FIG. 1. A reference numeral 301 depicts a CPU for use in controlling that apparatus, 302 a recording unit, which is constructed with a RAM, a ROM and/or a hard disk, etc., thereby to be used for the database, which is constructed with tables of information or the like, or others, such as, for recording of data and/or for execution of programs, etc. A reference numeral 303 depicts an input unit, and it is used when conducting an operation, such as, maintenance of the index server, together with an output unit 304. A reference numeral 305 depicts a communication interface for making a connection with the network. As the index server can be used a general server or a PC (Personal Computer).

FIG. 4 is an explanatory view of the networked monitor 103 shown in FIG. 1. A reference numeral 401 depicts a CPU for use in controlling the apparatus, 402 a recording unit, which is constructed with a RAM, a ROM and/or a hard disk, etc., thereby to be used for temporary reservation of the pictures received, or others, such as, for recording data, and/or for executing programs, etc. A reference numeral 403 is an input unit, and it is an input apparatus to be used, in particular, when making operations on buttons for giving informing to the networked camera or an object, having a contract for monitoring on the networked monitor that is taken in by means of the networked camera or the microphone, or for conducting operations, such as, maintenance of the camera for taking a picture and/or the networked monitor, etc., for example. A reference numeral 404 is an output unit (a display unit) is used for displaying the video and the audio transmitted from the networked camera, or for displaying information of, such as, the networked camera, the object and/or a map, etc., or when conducting operation, such as, for maintenance on the networked camera, etc. A reference numeral 405 is a communication interface for making a connection with the network. As the networked monitor can be used a general server or a PC (Personal Computer).

FIG. 5 is the structure view of the storage 104 shown in FIG. 1. A reference numeral 501 depicts a CPU for use of controlling the apparatus, 502 a recording unit, which is constructed with a RAM, a ROM and/or a hard disk, etc., thereby to be used for temporary reservation of the pictures received, or others, such as, for recording data and/or executing programs, etc. A reference numeral 503 depicts an input unit, and it is used when conducting operations, such as, maintenance of the storage, etc., together with an output unit of 504. A reference numeral 505 is a communication interface for making a connection with the network. As the storage can be used a general server or a PC (Personal Computer).

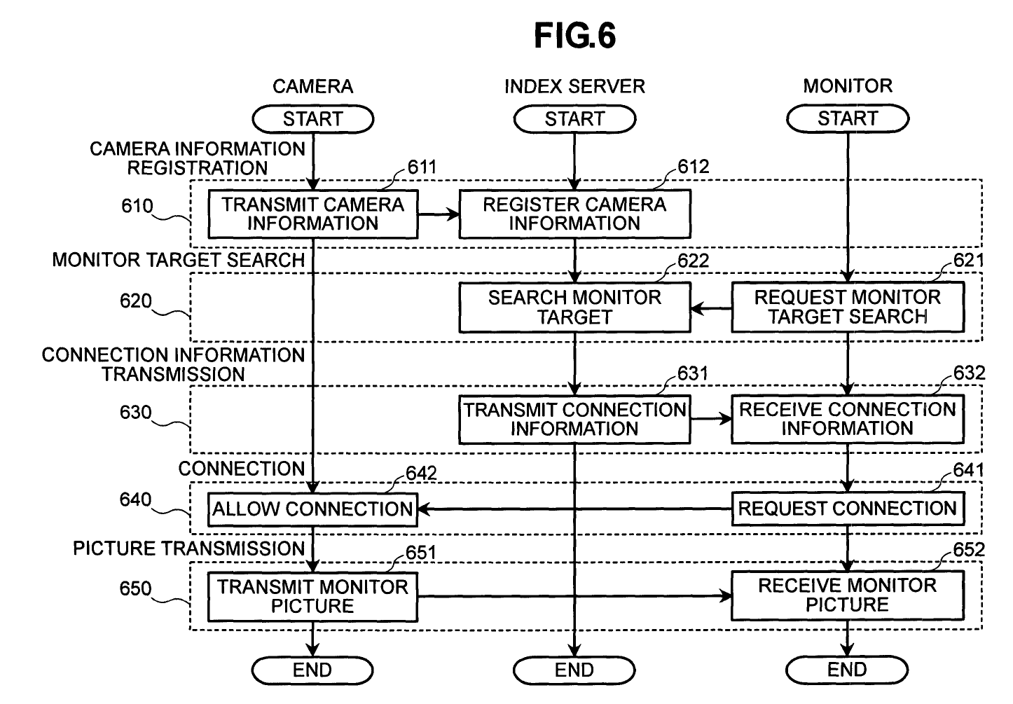

FIG. 6 is a flowchart for showing basic operation of the networked camera system shown in FIG. 1. In a camera information registration step 601 for registering information of the camera, the networked camera transmits the networked camera information to the index server (611), and the index server reserves the networked camera information therein (612). Detailed example of the networked camera information will be mentioned later.

In a monitoring object searching step 620, the networked monitor requests a search for a monitoring object to the index server (621). The monitoring object is, such as, an ID of a specific networked camera and/or a road/area, etc., on which the monitoring is required, and the above-mentioned networked camera information is held therein, as it is, or together with an index of the information relating thereto. If in the information of the monitoring object search request is included search keys for those indexes, it is possible to make a search for the monitoring object. The index server makes a search, upon basis of the information of the monitoring object search, which is received (622). As a result of the search, if one or more networked cameras is/are detected, then the process advances into a next step, however if no networked camera can be detected, the present process is ended. Next, in a connection information transmission step 630, such as, an ID or URL (Uniform Resource Locator), etc., (hereinafter, “connection information”) of the networked camera(s) detected in the step 622, is transmitted to the networked monitor (631). The networked monitor receives the connection information (632).

In a connection step 640, the networked monitor transmits a connection request to a predetermined networked camera (641). The networked camera, responding to the request, advances the process to the next step when allowing the connection (642). When not allowing the connection, the present process is ended. The case, where the connection is allowed, is for example, when the ID of the networked monitor at the origination of the connection request is allowed to be connected to the networked camera, and the allowance is made in the similar process of a login into a general network or the PC, etc., through, such as, certifying a password, the number of users connecting at the same time, etc. On the other hand, when not allowed, the process is also similar thereto. Next, in the picture transmission step 650, the networked camera and the networked monitor are connected with each other, and therefore the networked camera transmits the video/audio or the like to the networked monitor, but not through the index server (651). The networked monitor reproduces/displays the video/audio received (652). Up to the above, all the flows are ended. However, any one of the steps may be operated in non-synchronism with, or any one of the steps may be operated, repetitively. The processing in those network system also corresponds to the non-synchronism, the repetition and the ending on the way, in the similar manner, in the flowchart thereafter.

FIG. 7 shows the detailed contents of the networked camera information mentioned in FIG. 6. A reference numeral 701 is the ID of the networked camera. A reference numeral 702 is the ID indicative of a possession of the networked camera. Reference numerals 703 and 704 indicate the latitude and the longitude of the networked camera, respectively. A reference numeral 705 indicates a zip number or code at the location of the networked camera. A reference numeral 706 indicates an ID of the road on which the networked camera is provided. A reference numeral 707 indicates a starting point of the road where the networked camera is provided. A reference numeral 708 is the URL indicative of the location of the networked camera on the network. The reference numerals 701 and 702 are the IDS identifying the networked camera and the owner thereof, and the reference numerals from 703 to 708 are data indicative of the location of the networked cameras, on the geography and on the network. With using the information, it is possible to make a search on the networked camera from the position of the monitoring object.

FIG. 8 shows the detailed contents of the connection information mentioned in FIG. 6. A reference numeral 801 indicates an ID of the networked camera. Reference numerals 802 to 806 indicate the latitude, the longitude, the zip number or code, the road ID, and the road position of the networked camera, respectively, and any one of those is data, being indicative of the position on the geography. A reference 807 is data indicative of the position of the networked camera on the network. With using the information, the networked monitor is able to use the position information for displaying the networked camera, such as, a map on the networked monitor, or can be connected to the networked camera on the network. Other than those, for example, the networked monitor registers the IDS of the said networked monitors in the index server upon receipt of the contract and/or a certificate in advance, and further it may gives a special keyword, such as a password, for example, to the present connection information.

Next, explanation will be given on an information table held in the index server 102. Within the index server is held the connection information in the form of database, however also said connection information may hold others, such as, a list of IDs of the networked monitors from which un-processed picture can be obtained, a list of IDs of the networked monitors from which processed picture can be obtained, and a list of IDs of the networked monitors through which no picture can be obtained. Also, for give it to the connection information, it is also possible for the index server to hold a password for obtaining an un-processed picture or a password for obtaining the processed picture.

Next, explanation will be given on the connection to the networked camera. With the connection having no limitation, the networked camera transmits a picture to the networked monitor when it requires the picture, however with the connection having a limitation thereon, the picture is transmitted, for example, when the ID of the networked monitor held in the networked camera is coincident with the ID of the networked monitor requesting the connection, while the connection is rejected when they are not. Also, in the case where the connection is made, it may be possible to transmit the un-processed picture dependent upon the ID of the networked monitor, or to transmit the processed picture, or to reject the connection. In the similar manner, it is also possible to use the password in the place of the IDs. In this case, the networked monitor makes the connection by using the password described in the connection information, which is obtained from the index server. In this instance, the networked camera may transmit the un-processed picture or the processed one, depending upon the password.

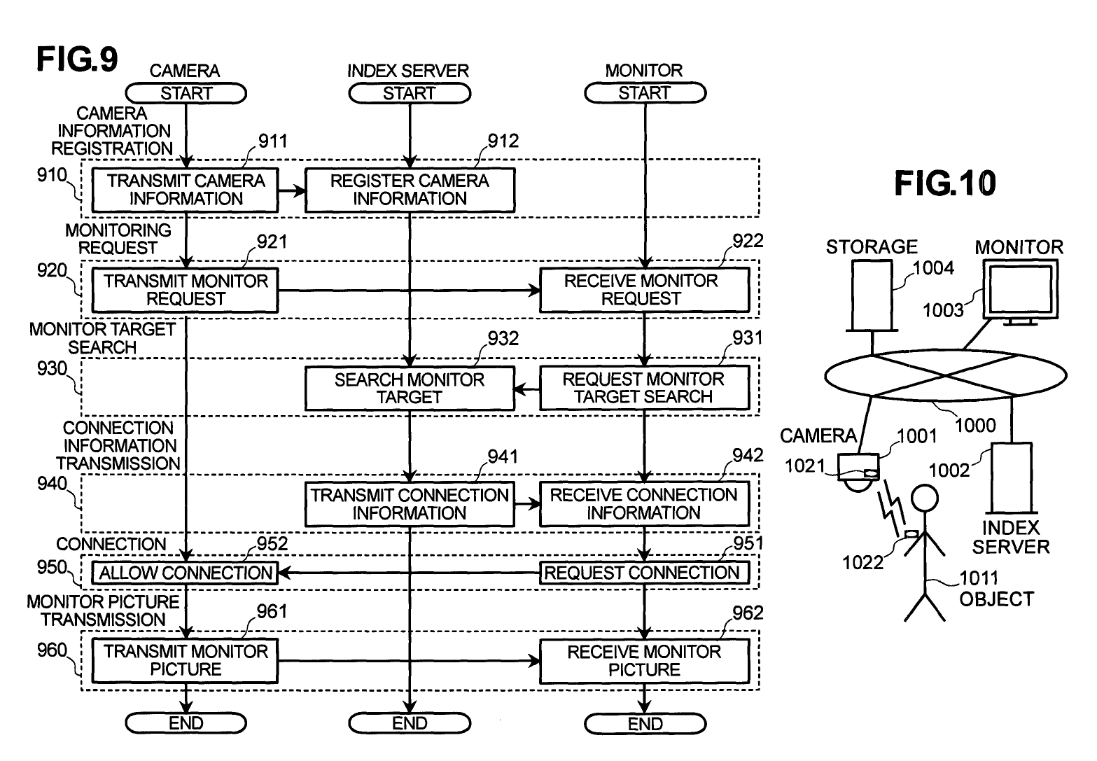

FIG. 9 shows a flow chart for transmitting a monitored picture, in particular, in the case when the networked camera or the owner thereof makes a monitoring contract with the networked monitor. In a step 920 for requesting a monitoring, the networked camera transmits a request for monitoring to the networked monitor (921). Upon receipt of the request for monitoring, the networked monitor shifts into a next step (922). In a step 930 for searching the monitoring object, the networked monitor transmits a search request for the monitoring object to the index server (931), and the index server makes a search on the monitoring object. In a step 940 for transmitting the connection information, the index server transmits the connection information, from a result of the search (941), and the networked monitor conducts the connection in the next step upon the basis of the connection information received. Though, the steps 930 and 940 are necessary when no connection information is received in the monitoring request step 920, they may be omitted if the information corresponding to the connection information can be received in the step 920. In a step 950 for connecting to the networked camera, the networked monitor transmits the connection request to the networked camera (951), while the networked camera allows the connection in the case when the networked monitor requesting the connection is one, which can be connected with. The networked monitor that can be connected with is the such that, for example, it is permitted to connect with when the same password is contained in the connection information, including therein the password in the networked camera information in the step 910, or when only the connection request from that networked monitor is allowed while obtaining the IDs of the networked monitors requesting the monitoring from the networked monitor in the step 920, or when allowing the connection requests from all of the networked monitors. Next, in a step 960 for image transmission, the networked camera transmits the video/audio to the networked monitor (961). Receiving the video/audio, etc., the networked monitor reproduces and/or displays them (962). Up to the above, all of the flows end. However, any one of the steps may be operated in non-synchronism with, or any one of the steps may be operated, repetitively.

The monitoring contact between the networked camera mentioned above and the networked monitor may be made on the basis of the location information of the networked cameras. For example, in a case where a section A of a city X and the networked monitor make the monitoring contract therebetween, and in particular, when all of the networked cameras in the section A are subject of the monitoring contract, the monitoring contract covering the area can be made by using the zip codes contained in the networked camera information, to be a condition of searching the monitoring object. Also, it may be such the contact of observing all of the cameras, which can be searched out by the keyword, while registering the same keyword, such as, a random number of twenty (20) digits, in the networked camera information of the networked cameras in the areas. With the monitoring contract on those areas, there may be one, including all of the networked cameras having the same keyword in the monitoring contract, or one making up the monitoring contract by loosing the searching condition of the networked camera information by, such as, designating the zip code up to only the upper five (5) digits in the searching condition, for example, or one making up the monitoring contract by using the IDs and the URLs of all the networked cameras.

FIG. 10 is a view for showing other embodiment of the networked camera system according to the present invention, in which monitoring is made on a specific object, such as, a person or a car, etc., as a subject thereof. A reference numeral 1000 indicates a network, 1001 a networked camera, 1002 an index server, which is used for indicating the location of the networked camera and a storage on the network and also for holding various information tables therein, thereby facilitating a search between respective terminals, 1003 an apparatus for displaying thereon an image of the networked camera or a monitor for displaying thereon the apparatus and a person, and 1004 a storage for storing therein video/audio taken by the networked camera and the position information, etc. An object 1011 and the networked camera 1001 can detect that, both of them lie in the neighborhood with each other by making communication through communication apparatuses 1021 and 1022. Those communication apparatuses are same to a radio wave receiver for use of sensing and a sensor for use of sensing, respect9vely, which will be explained by referring to FIG. 13, or it is also possible to use any kind of apparatus for detecting that they lie in the neighborhood with each other. Also, the storage 1004 may be omitted if it is not necessary to reserve the video or image therein.

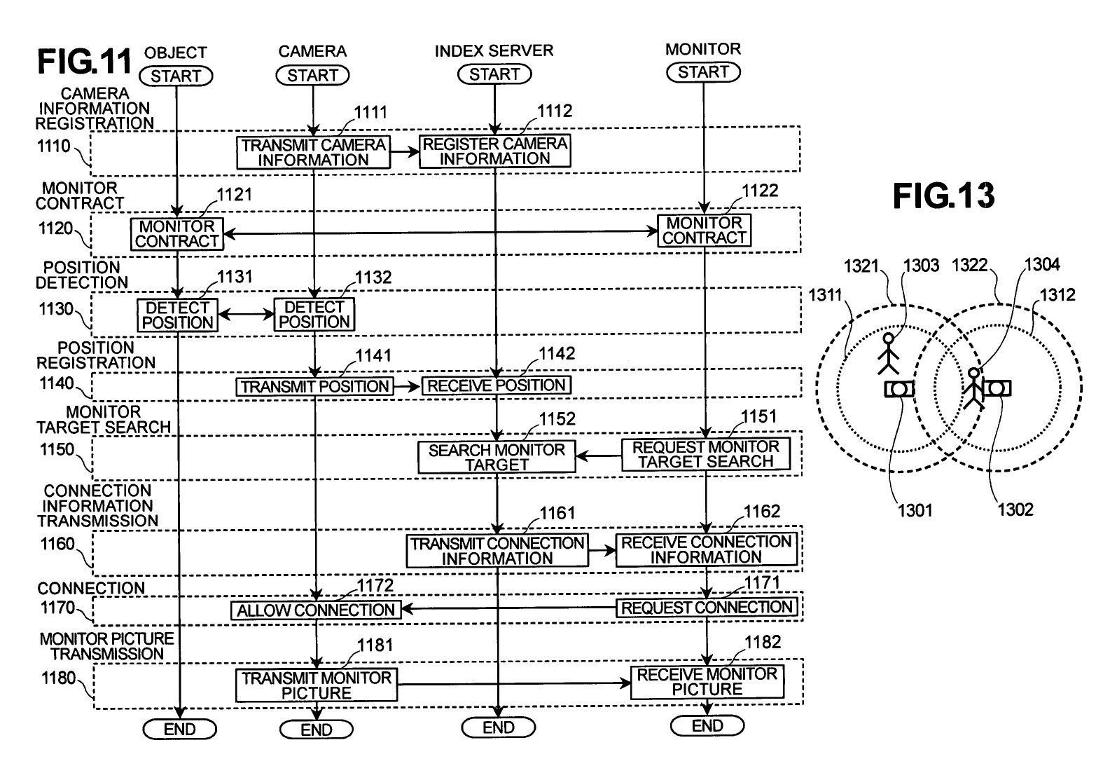

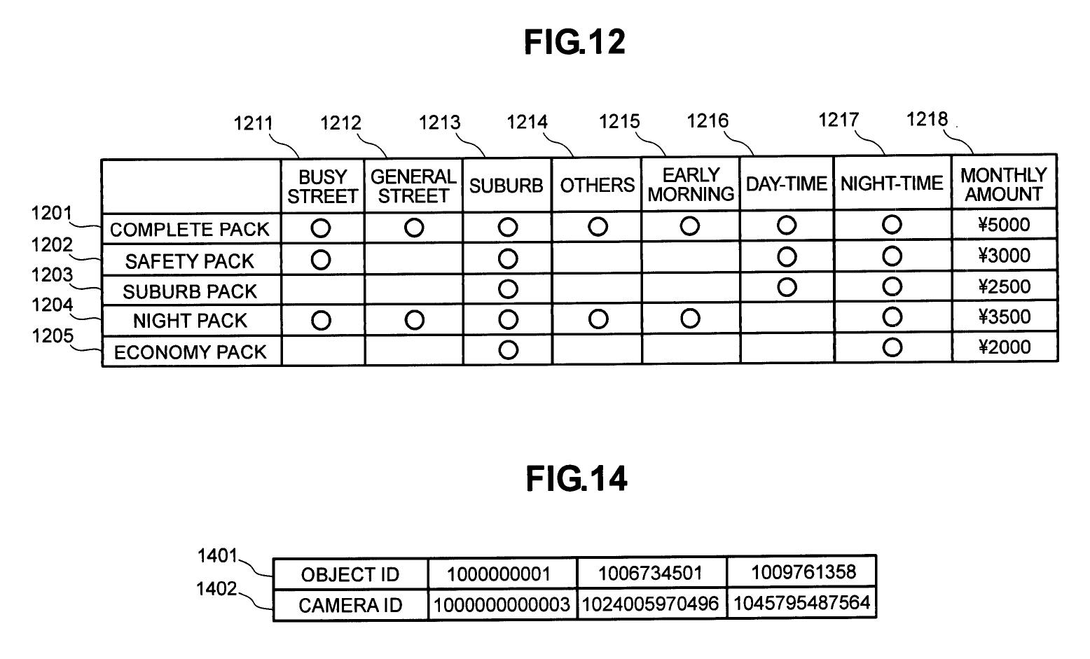

FIG. 11 shows a flowchart for conducting a monitoring contract by making the object as to be the subject. In a step 1110, the networked camera transmits the networked camera information to the index server (1111). The index server registers the networked camera information therein (1112). In a step 1120, a monitoring contract is made between the object and the networked monitor (1121, 1122). An example of the monitoring contact will be explained by referring to FIG. 12. In a step 1130, detection is made on the position of the object (1131, 1132). The detection of position of the object will be explained by referring to FIG. 13. With the detection of position of the object, the position of the object is specified. In a step 1140, the networked camera transmits the position information of the object to the index server (1141). Upon receipt of the position information of the object, the index server registers it therein (1142). In a step 1150, the networked monitor requests a search for the object, as the monitoring target, to the index server, upon the basis of the monitoring contract (1151). Upon the monitoring contract, the index server makes a search on the object (1152). In the search of the object, the networked camera is searched out, which is capturing the position of the object and the image of the object, by using the object information registered in the index server. In a step 1160, the connection information to the networked camera, which is searched out in the search, is transmitted to the networked monitor (1161), and the networked monitor starts a next step upon receipt of the connection information (1162). In a step 1170, the networked monitor makes a request of connection to the networked camera (1171), and the networked camera allows the connection if the networked monitor can connect with (1172). In a step 1180, the networked camera transmits the video/audio (1181), and the networked monitor makes reproduction/display thereof (1182). Up to the above, all of the flows end. However, any one of the steps may be operated in non-synchronism with, or any one of the steps may be operated, repetitively. Further, it is also possible for the networked camera or the networked monitor or the object, to select between a moving picture and a static picture, when the networked camera transmits the video. This may be made upon the basis of the monitoring contact, or may be set up at a radio wave terminal, which is held by the object, so as to be transmitted to the networked monitor when sensing. Or in the case where movement occurs frequently between the networked cameras, for example, during the movement by means of a car, etc., it is also possible that the networked monitor or the networked camera detects it, thereby designating transmission of the static picture.

Also, in the flowchart shown in FIG. 11, though the steps are in such that, search for the object is made on the index server through the searching by means of the networked monitor, and the connection information is transmitted to the networked monitor, however it is also possible that the networked monitor registers a portion of the object information, such as, an object ID of the search target into the index server or the networked camera, in advance, then the connection information is transmitted to the networked monitor when the index server or the networked camera detects the said object. In this case, the step 1151 in the steps 1150 comes to “monitoring object information transmission”, and the step 1152 therein to “monitoring object registration”. Also, the step 1161 starts the operation thereof upon detection of the monitoring object registered.

FIG. 12 is an explanatory view of an example of the monitoring contract. Reference numerals 1201 to 1205 indicate names of the monitoring contacts. Also, reference numerals 1211 to 1214 are the monitoring contacts depending upon the locations, and reference numerals 1215 to 1217 are the monitoring contracts depending upon times. A reference numeral 1218 indicates fee for every month, for the monitoring contacts. For example, a reference numeral 1201 is a “safety pack” in the title thereof, and the monitoring is conducted only during the day-time and the night-time in a busy street, such as, a downtown area, and a suburb area. The fee is 3,000 yen per a month. As such the monitoring contact can be listed up, in the followings: for example, a monitoring contract, which is executed at a constant distance from a home, or a monitoring contact, which is executed only on a road from the home to a business place, a monitoring contract, in which time for starting and time for ending can be designated onto the monitoring, a monitoring contract, in which designation is made by the ages and the distinction of sex, but without designating the ID of the object, and a monitoring contract, which is executed on all members of a family, etc. And, also other than those, there can be considered such a monitoring contract, in which the monitoring target includes the networked camera being in the vicinity of the nearest networked camera of the object, or in which the monitoring target further includes the networked camera existing in the vicinity of that networked camera, etc., for example.

FIG. 13 is an explanatory view for position detection of the object. Reference numerals 1301 and 1302 indicate networked cameras, 1303 and 1304 the objects, each holding an apparatus or device for receiving a radio wave for use of sensing, or an apparatus for identifying the position thereof, such as, a GPS, etc. Also, a reference numeral 1311 indicates an area where the networked camera 1301 can monitor, while 1312 an area where the networked camera 1302 can monitor. The area where the monitoring can be made means an area where the picture or image obtained is equal or greater than a preset value in the resolution thereof, or the like, and it is composed of exchangeable values, such as, a brightness, weather, time and other factors, for example. For example, in a case where the resolution of the picture may be low, the area where the monitoring can be made is widen, on the contrary in a case where a high resolution power is needed, the area where the monitoring can be made is narrowed. A reference numeral 1322 indicates a region where the radio wave for use of sensing the networked camera can reach (hereinafter, being called by “sensing region”). The radio wave for use of sensing can be narrowed in the reachable area thereof by bringing the radio wave of the networked camera side to have a directivity, in particular, in a case of the radio wave communication enabling to find each other automatically, among the radio wave communications enabling to communicate with each other, for example. Also, it is possible to weaken the radio wave in an output thereof, or to use infrared rays instead of the radio waves. Furthermore, it is also possible to replace the region where the radio wave for use of sensing can reach to, by capturing the position information more correctly with using a GPS (Global Positioning System) and transmitting it to the index server and the networked camera. In this instance, for example, when the object 1303 enters into the area 1321, it means that the networked camera detects the object. With those methods, the object entering into the sensing region can be detected by means of the networked camera. Upon detection of the object, the networked camera transmits the object information to the index server. The index server, holding the tables of the object information, which will be explained by referring to FIG. 14, detects change of the object information, and thereby executes the step 940 with using the connection information of the networked camera located where the object is existing. The change of the object information means, such as, that change occurs in the existence of the object within the sensing region of the networked camera, for example. Further, in an inside and an outside of a circle in the figure, vice versa.

FIG. 14 shows a table of the object information, which is held in the index server. In the present table, object information of three (3) pieces of the objects is described therein. The object information is composed of an object ID 1401, and an ID of the networked camera 1402. With this, it is possible for the index server to know which object exists, in which sensing region of the networked camera. Also, as the object information on the index server, it is possible to hold the ID of the networked monitor, which enables to search out the object information, and/or a password, etc., together with the object information on the index server, in the similar manner to the table of the connection information. In this case, it is possible to restrict the networked monitors that can search out the object information.

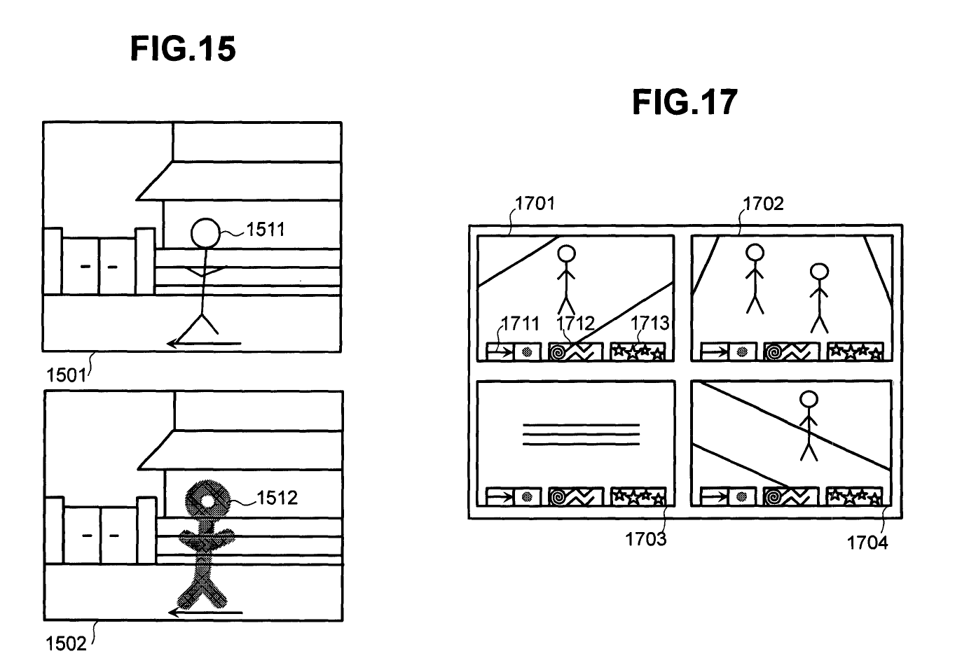

FIG. 15 is an explanatory view of the video processing on the picture or image of the networked camera. A reference numeral 1501 indicates the picture before processing, while 1502 the picture after processing. In general, the picture of the networked camera can be classified into a background and an object. Generally, the background is still, but ordinarily, the object moves. For this reason, a moving picture portion is extracted, and the video processing, such as, a mosaic is treated on that moving picture portion, thereby it is possible to make processing on it in such a degree, that the object cannot be discriminated on a face, etc. Since this processing enables to bring the object of 1511 into the picture being obscure, as shown by 1512, it is possible to protect privacy. Also, the video processing can be made, selectively, depending upon the connection request of the networked monitor 641, 951 or 1171. For example, if an ID of the object is included in the connection request of the networked monitor, and if the object corresponding thereto exists in the sensing region of the networked monitor, the picture is transmitted without conducting the video processing thereon, but if not included the ID corresponding thereto, the picture is transmitted with conducting the video processing thereon.

The networked monitor can transmit the audio and/or video, as well as, a signal, with using a microphone and a camera. For example, when a sound “Stop” is pronounced toward the microphone, it is produced from a speaker, which is built within the networked camera. Also, an alarm button is pushed down on the networked monitor, a buzzer, which is built within the networked camera, breaks into sound. Also, pushing-down on an information button may reports it to a police or a security company, for example.

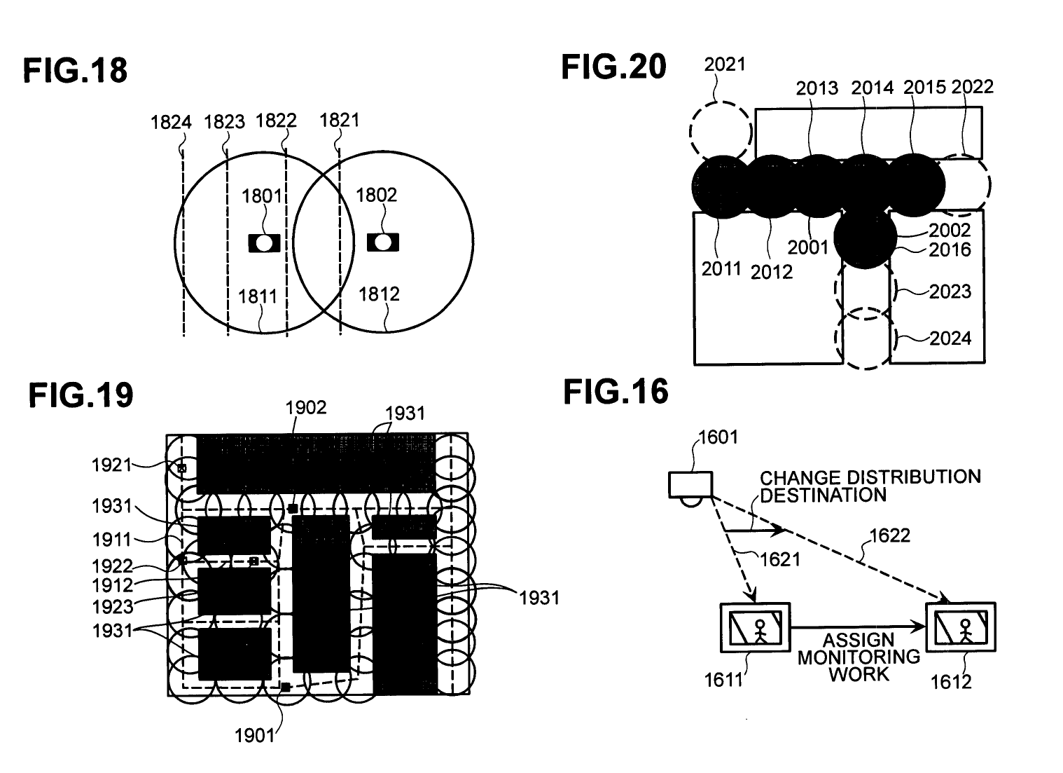

FIG. 16 is an explanatory view for showing the monitoring by means of a plural number of the networked monitors. The picture of the networked camera 1601 is transmitted to the networked monitor 1611, but due to operation of the networked monitor, etc., the destination of transmission can be shifted to the networked monitor 1612. As a method for shifting the destination of transmission, for example, the connection information is transmitted to the networked monitor 1612, or a request for continuing monitoring operation to the networked monitor 1612, etc., and then the monitor 1612 transmits the connection request to the networked camera 1601, thereby enabling to succeed the monitoring operation. In this instance, if it is during the monitoring on the object, the object information can be transmitted. For example, in a case where a watcher of the networked monitor 1611 is a person who does not know the culture in the country of the networked camera 1601, and if he/she cannot decide to push down a police button or not, the monitoring operation is taken over to a networked monitor 1612, which is operated by a watcher who knows the culture of the country, where the networked cameral 1601 exists, well. Also, when an accident, or the like, occurs on the networked camera 1611, it can be taken over to the other networked monitor, easily, in the similar manner. Also, the succeeding networked monitor may speak to the speaker, which is built within the networked camera 1601, or further the succeeding networked monitor may telephone to the telephone number of the object, which is described in the object information.

FIG. 17 shows an example of the image or picture displayed on the networked monitor 1611, in a case where the monitoring is made by the plural number of the networked monitors shown in FIG. 16. The present example shows a case where the networked monitor exists in a country other than that where the networked camera exists, and wherein the monitoring is made on four (4) pieces of the objects, at the same time. Reference numerals 1701 to 1704 indicate the screens, showing the objects thereon, respectively, and 1703 indicates that the object is not captured by three (3) pieces of horizontal lines since the object does not enters into the sensing region. Also, a reference numeral 711 is a button on the screen, for the purpose of changing the distribution destination of the picture to the networked monitor 1612, or giving information thereto, when it is impossible to deal with, or to make decision on this networked monitor. A reference numeral 1712 is a button on the screen for generating an alarming sound from the speaker of the networked camera. A reference numeral 1713 is a button on the screen, for use in an optical alarming, such as, a red-color rotary lamp and/or a flash, etc. An operator is able to make a report when a suspicious situation occurs on the picture displayed on the screen, by using those buttons 1711 to 1713.

FIG. 18 is an explanatory view, wherein an image is newly produced with using the pictures of the networked camera, which applies a fish-eye lens or the like, therein. Reference numerals 1821 to 1824 are examples of the backgrounds, which can be viewed when walk is taken along an arrow, wherein a straight line corresponds to a field of vision. In this instance, when producing the background, which can be seen when moving in a direction of the arrow, for example, with using the networked cameras 1801 and 1802, the backgrounds 1821 and 1822, for example, can be produced by deforming the image or picture taken by the networked camera 1802. Also the backgrounds 1823 can be produced by means of the networked camera 1802, however since the image is expected to be roughened, the backgrounds 1823 and 1824 are produced with using the networked camera 1801 locating in the vicinity thereof, much more. With producing an image cut out vertically on a passageway in this manner, thereby distributing it to the networked monitor, it is possible to give an image of walking. In the similar manner, regardless the vertical, with composing and processing the images or pictures of the plural number of networked cameras, the networked monitor can show an image of moving in the vicinity of the networked cameras.

FIG. 19 is a view for showing mapping of the locations of the networked cameras on a map. Each circle indicates the sensing region for each the networked camera, a region other than 1931 shows a road, and a dotted line the road but without taking width of the road into the consideration. The roads are given with the road IDs, respectively, and the position on the road can be identified from the road ID and the road position, by determining a starting point. Also, with holding a table of information relating to connection between the roads, it is possible to search out all of the networked cameras within a range of 100 m upon the basis of the position on a certain road, for example. With using this, for example, when wishing to take a walk from a point 1901 up to a point 1902 with using the networked cameras, it is possible to take a walk, imaginarily, with using a remote controller attached with direction keys or the like thereon, applying the method shown in FIG. 18. In this case, the imaginarily existing position and the direction thereof may be displayed on the map, while displaying the image corresponding thereto. Also, it is possible to designate a route of the imaginary walk by means of the road ID and the road position. For example, it is possible to use the images, starting from the position 1921 on the road 1911, reaching to the position 1922 along the road 1911, and reaching to the point 1923 by turning to the left onto the road 1912, for the imaginary walk mentioned previously.

Also, with using the monitoring of the object in common, it is possible for the networked monitor to make a prediction on an approach of a suspicious person, by checking the image of the networked camera, on which the object does not enters into the sensing region, locating in the vicinity of the object. With this, explanation will be given, in particular, about an early alarming system of a suspicious person, by referring to FIG. 20. A reference numeral 2001 indicates an object, and 2002 the suspicious person. For example, it is assumed that the monitoring contract on the object includes all of the networked cameras into the monitoring object, from the networked camera nearest to the object up to that of a hop number 2. Herein, the hop number means a distance from a networked camera of a reference, counting the networked camera by one (1), i.e., the networked camera of the reference has “0” in the hop number, the neighboring one “1”, and the further neighboring one “2”. In this FIG. 20, a reference numeral 2012 is the networked camera of the reference, 2012 and 2014 are the cameras of the hop number 1, and 2011, 2015 and 2016 are the cameras of the hop number 2, respectively. With the monitoring contact of the hop number 2, all the networked cameras 2011 to 2016 are the cameras of the monitoring object, but those from 2021 to 2024 are out of the monitoring object. In this instance, if assuming that the networked monitor confirms that the suspicious person appears on the networked camera 2016, the networked monitor conducts the operation of transferring an alarm to the object 2001 upon the basis of the monitoring contract. For example, it can give a report to a mobile telephone of the object 2001, or generate voices or flash a light, or alternately, sound a siren on the networked camera 2014 nearest to the suspicious person. With this, the object is able to escape from a danger, in advance.

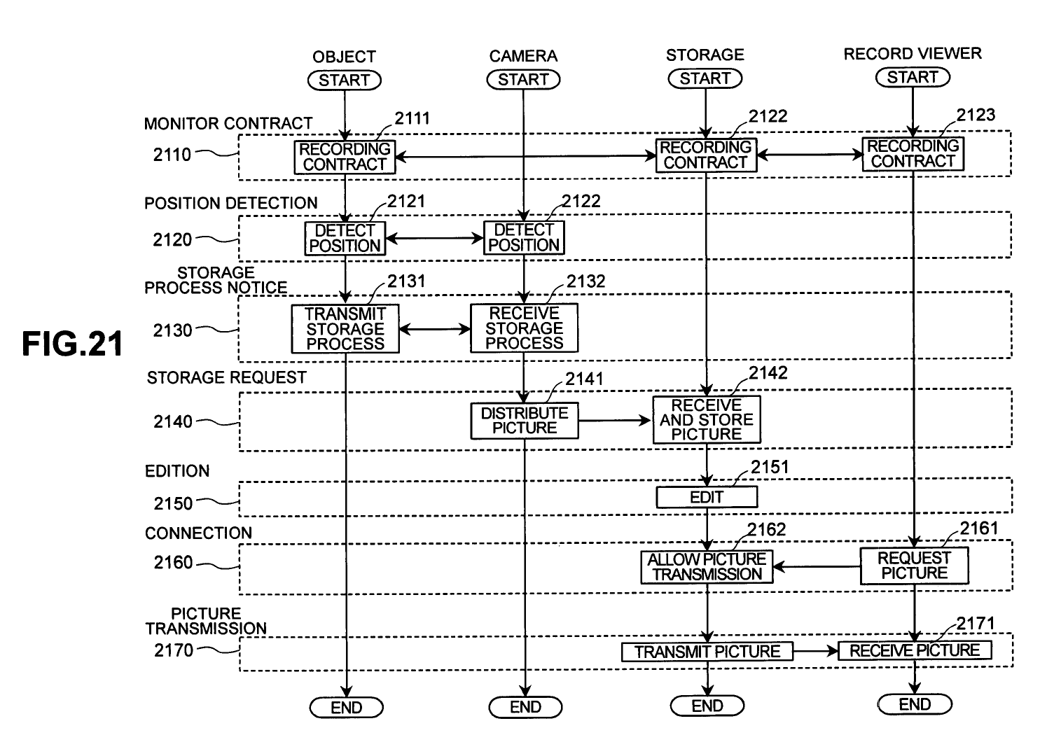

FIG. 21 shows a flowchart for recording of the monitoring image or pictures with using the storage. In a step 2110, a recording contract for the monitoring pictures is made between the object, the storage, and a record viewer (2111, 2112, 2113). The recording contract means, such as, a contract of recording all or a portion of the pictures when the object enters into the sensing region, or recording the pictures in a certain area, etc., for example. The object produces the storage information upon the basis of the recording contact. In the storage information means are described information for the connection, such as, the URL or the password of the storage, etc., for example, and a condition for the networked camera to transmit the images to the storage, etc. The condition for transmitting to the storage includes therein, such as, a case where the location of the networked camera is indicted by the specific zip code or an area, for example. The storage records only the pictures based on the recording contact. The record viewer is a terminal being able to receive the pictures, which the storage records therein, such as, the images obtained based on the recording contract from the storage, and it may be the same to the object. For example, when applying the present method into a traveling report, the object is the same to the record viewer, in general. In a step 2120, the position of the object is detected (2121, 2122). For example, when the object enters into the sensing region of the networked camera, the networked camera detects the object. The object can know the position of itself, with being informed thereof by the networked camera. In this instance, it is out of the area of the recording contract, the process does not proceed into a next step. In a step 2130, the object transmits a storage process to the networked camera (2131). The storage process means information, such as, the URL and/or the password, being necessary for the networked camera to distribute the images to the storage, for example. The networked camera distributes the images to the storage upon the basis of the storage process (2141). In this instance, the networked camera may deliver the password, etc., to the storage, upon the basis of the storage process. Upon receipt of the images, the storage stores them into a recording medium, such as, a memory, a hard disk, an optical disc, etc., for example (2142). In a step 2150, the storage edits the pictures stored therein (2151). A method for editing includes compression of the picture by extracting thereof, and all other processes for processing the pictures, so as to be seen, easily. In a step 2160, the record viewer requests the picture to the storage (2161), and then the storage compares the request of the record viewer to the recording contract, thereby allowing the distribution of the pictures if the recording contract permits to distribute it to the record viewer (2162), and then executes a next step. In a step 2170, the storage transmits the pictures (2171), and the record viewer receives the pictures (2172). Up to the above, all of the flows end. However, any one of the steps may be operated in non-synchronism with, or any one of the steps may be operated, repetitively.

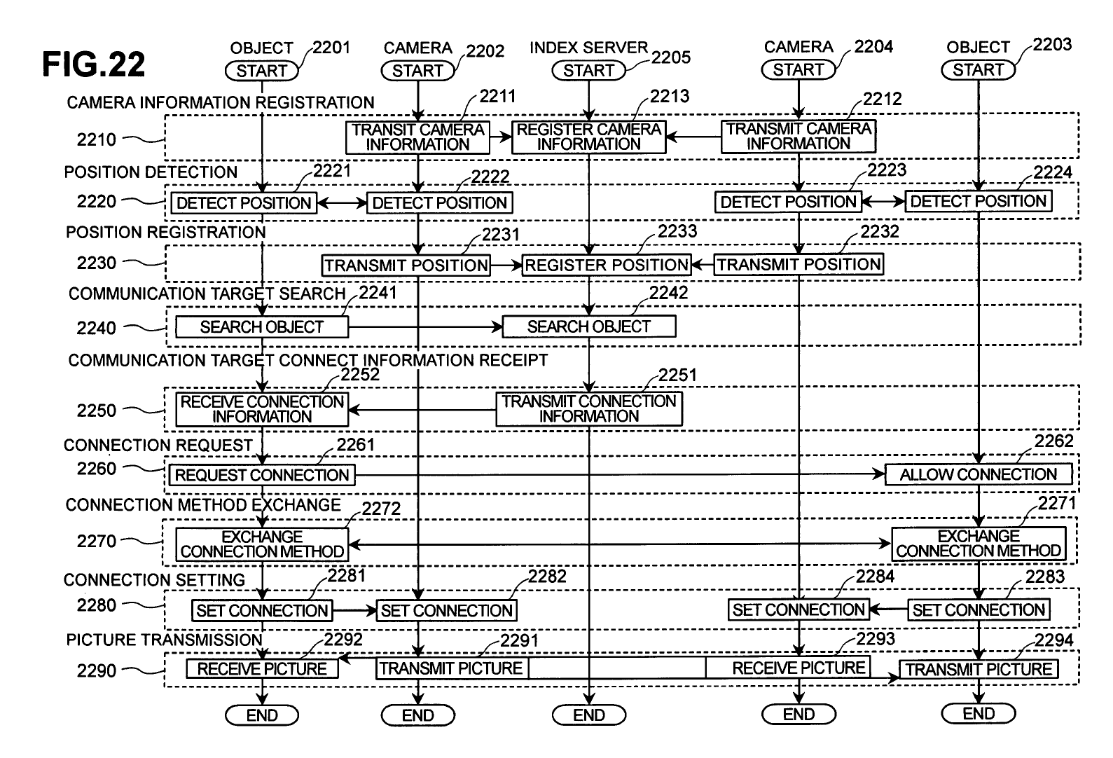

FIG. 22 shows a flowchart for making communication between the objects, with using the networked cameras. With the present flowchart, explanation will be given on a case where an object 2201 starts communication to an object 2203. It is assumed that the object 2201 enters into the sensing region of a networked camera 2201 when it conducts the communication. In the similar manner, it is assumed that the object 2203 enters into the sensing region of a networked camera 2204 when it conducts the communication. In a step 2210, the networked camera registers the networked camera information into the index server (2211 to 2213). The present step is an operation to be conducted when setting up and/or restarting the networked camera, and it may be omitted when the networked camera information is already registered in the index server. In a step 2220, the networked camera detects the position of the object (2221 to 2224). In a step 2230, the networked camera registers the position information of the object into the index server (2231 to 2233). The steps 2220 and 2230 are for preparation of making a search on the object, and if the networked camera is changed for use in the communication accompanying with movement of the object, the steps 2220 and 2230 are conducted, repetitively. In a step 2240, the object conducting the communication is searched out with using the index server (2241, 2242). In this instance, the keyword for search is an ID and/or a name of the object, for example. In a step 2250, information for connection to the object 2203 is transmitted when the object corresponding thereto can be found in the index server (2251). The information for connection is the URL, etc., for example. Upon receipt of the information for connection (2252), the object starts a next step. In a step 2260, the object 2201 requests connection to the object 2201, with using the information for connection (2261). The object 2203 allows the connection when a user operation or an automatic response is turned into “ON”, or when setting up is made so as to allow the connection of the object generating the connection request there from (2262). In a step 2270, the connecting methods are exchanged between the objects (2271, 2272). Exchange of the connecting methods means the exchange on the methods for communicating the pictures through the networked cameras; such as, the URL, a speed of circuits, a desired resolution power, etc., are exchanged, for example. In a step 2280, setting up is made for communicating the pictures to the networked cameras with using the connecting method (2281 to 2284). In a step 2290, while taking the picture of the object 2201, the networked camera 2202 distributes the pictures to the object 2203 (2291). While taking the picture of the object 2201, the networked camera 2204 distributes the pictures to the object 2203 (2293). Upon receipt of the images, the object 2201 conducts reproduction/display thereof. In the similar manner, the object 2203 conducts reproduction/display thereof. However, any one of the steps may be operated in non-synchronism with, or any one of the steps may be operated, repetitively.

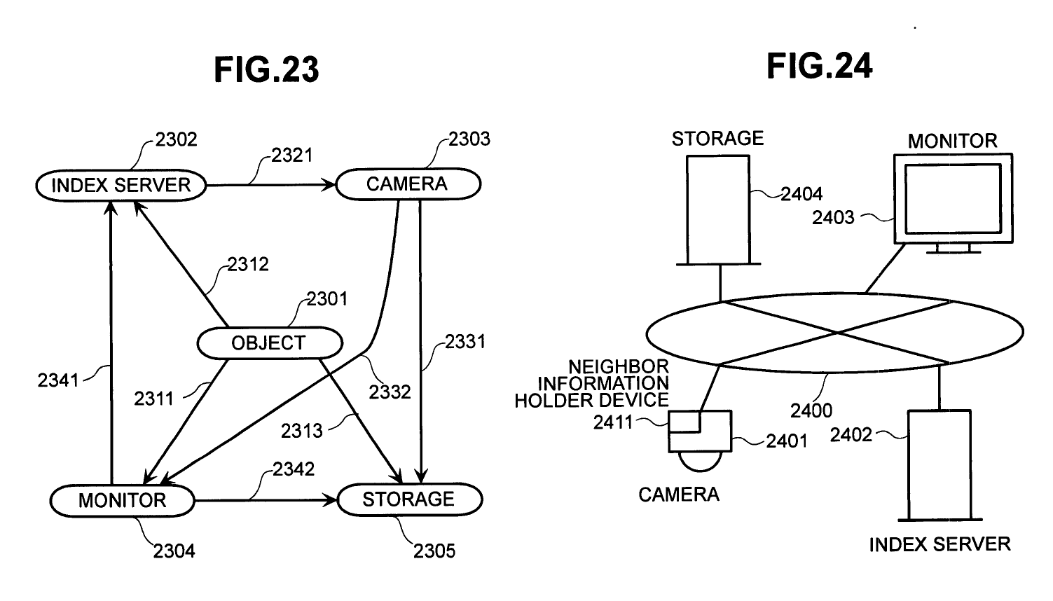

FIG. 23 is an explanatory view for an accounting model in the present system. In a case where the object 2301 concludes to enter into the monitoring contract with a networked monitor 2304, such as, that shown by the example of 1201 to 1205, the object 2301 pays a monitoring contract fee 2311 to the networked monitor 2304. Also, when using the index server for the communication, the object 2301 pays a fee for registration or an entrance fee 2312 to the index server. And also, when concluding to enter into the recording contract with the storage 2305, as shown by 2111 to 2113, the object 2301 pays the recording contact fee 2313 to the storage. The index server 2302 may pay a portion of the accounting income 2312 or 2341 to the networked camera 2303, as a rental fee, for example. The networked camera 2303 may pay a storage rental fee 2331, for reservation of the monitoring pictures, etc., to the storage 2305. Also, when concluding into such the monitoring contract with the networked monitor 2304, as shown by 921 and 922, the networked camera 2303 pays the monitoring contract fee 2332. The networked monitor 2304 may pay a portion of the accounting income 2311 or 2332 to the index server, as a rental fee, for example. Or, the networked monitor 2304 may pay a viewing fee 2342 to the storage 2305, for viewing the monitoring images stored therein.

Next, explanation will be given on the monitoring by means of such the plural number of networked monitors, as shown in FIG. 16. In a case reference numerals 1611 and 1612 are in the same company or in a form similar thereto, for example, where 1611 is a networked monitor of a low cost or of being operated by a worker of low wages, while 1612 a networked monitor of a high cost or of being operated by a worker of high wages, division of works can be made. In this instance, only with the monitoring on the monitor 1611, there is a possibility that an accuracy is low, for example, when deciding to be the crime or not, however in the case where the monitoring contact is made to be by the monitor 1611, then the monitor 1611 conducts the report. On a while, when conducting the monitoring with using the monitor 1612, too, the monitor 1611 requires the monitoring or the decision on the situation to the monitor 1612. With this, it is possible to made a decision being much higher in the accuracy thereof. With high or low in the accuracy, for example, in the case where a worker is an networked monitor, who lives in a culture area different from that of the object, there is high possibility of misunderstanding even a non-criminal situation to be the criminal one, due to the difference of the culture and customs, comparing to the worker who lives in the culture area being same to that of the object. In this case, it can be said that, the former is low in the accuracy, while the latter high in the accuracy thereof. Also, even within the same culture area, there is a possibility that a difference is caused in the accuracy, in the similar manner, due to an attitude of work and/or experiences of the worker. In this manner, when using the networked monitor being high in the accuracy thereof, there can be listed up various methods for accounting, such as, accounting periodically under the contact by introducing it therein in advance, a value-controlled system for accounting when using the networked monitor of high accuracy, etc. With the value-controlled system, the accounting can be made by a fact that the networked monitor causes a warning to the object.

Next, explanation will be given on a case where the present system is changed into a pair-to-pair system. In FIG. 1, if a platform software is installed onto the networked camera and the networked monitor, which uses a decentralization technology therein, for example, when information and data and programs corresponding to the functions, which the index server holds, are held by the networked camera and the networked monitor, distributedly, although comprising only the networked camera and the networked monitor as the apparatuses thereof, the index server is unnecessary as the apparatus. In this case, the construction of 101 to 103 can be obtained only by either one of the camera 101 and the monitor 103, and it is the equivalent to that comprising the elements 100 to 103 shown in FIG. 1. In the similar manner, it is also possible to use the networked camera and the networked monitor, and/or the index server, etc., as the storage.

FIG. 24 is an explanatory view for the structure having a neighbor information holder device in the networked camera.

A reference numeral 2400 has the similar functions of those 100 to 104 shown in FIG. 1, and further a neighbor information holder device 2411 is added thereto. The neighbor information holder device is a networked camera locating near to the networked camera 2401, i.e., a device for holding networked camera information relating to the camera 2401. For example, the information of the cameras located within 100 m from the camera 2401, and/or the information of the cameras, existing on the road, to which the camera 2401 belongs, and locating within 200 m from the camera 2401 by a distance measured on a route of the road. The neighbor information holder device can provide information of the cameras neighboring therewith responding to a request of the networked monitor, etc. The information of the cameras includes the URL and the password for connecting to the cameras.

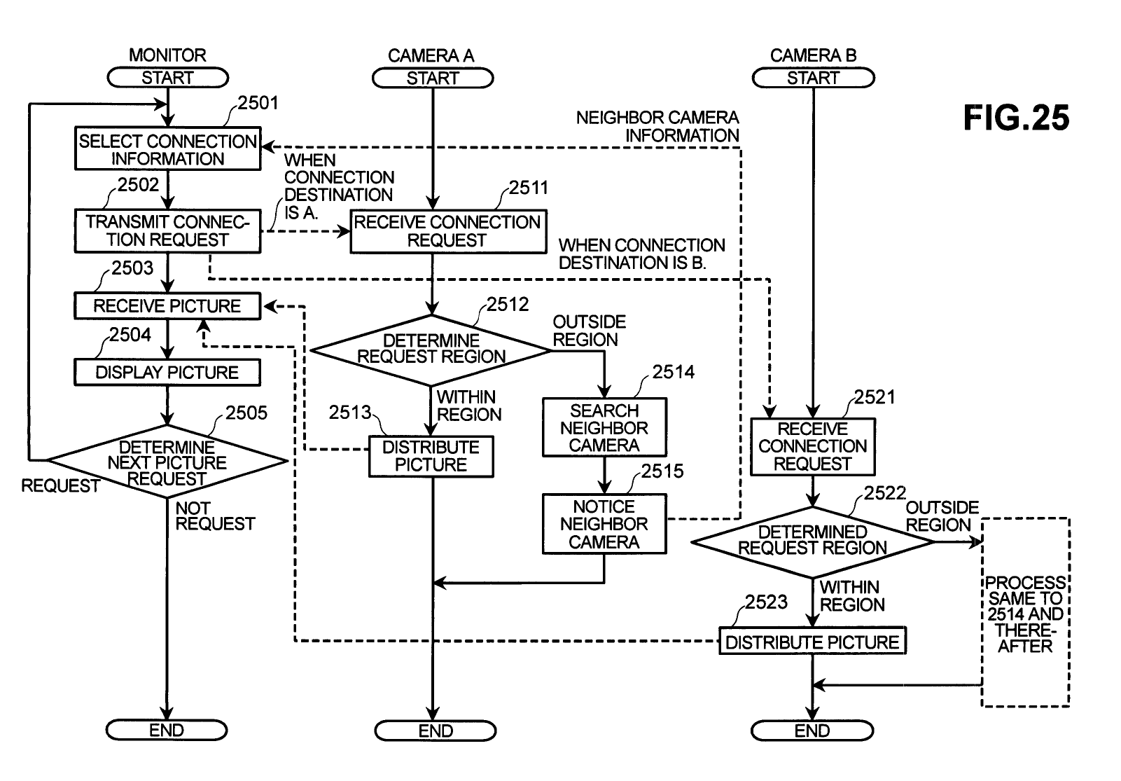

FIG. 25 is a flowchart for explaining the monitoring in the structure having the neighbor information holder device in the networked camera thereof. When the processing is started, the networked monitor selects one desiring the monitoring from the connection information (2501). Under the initial condition, it may be either the connection information, which is searched out with using the index server, the connection information, which is searched out with using the distributed index server held by the networked monitor, or the connection information, which is transmitted through the object. In this processing, the position information may be transmitted to the ordinary index server or the distributed index server, thereby obtaining the URL of the camera corresponding thereto. Or, the object may transmit the URL of the object and the URL of the networked monitor to the nearest networked camera, and the said networked camera transmits the URL of it self to the URL of the said networked monitor, thereby producing the connection information. When selecting the connection information desiring the monitoring, next the networked monitor transmits the connection request (2502). The transmission destination of the connection request is the selected connection information in the step 2501. The present example is a case where the connection is made to the networked camera A, at first. The networked monitor transmits the connection request, and the networked camera received the connection request (2511). In the connection request are included information of which kind of image is required, and information for identifying the place and/or the road name/position on the road, etc. Upon receipt of the connection request, the networked camera A determines if it can fulfill the connection request or not (2512). When deciding to fulfill the connection request, the networked camera A distributes the images (2513). The networked monitor receives the images distributed (2503). The networked monitor displays the images received (2504), and then it determines if requesting he next image or not (2505). The step 2505 may be requested automatically, after passing a constant time period by using a timer, for example. Or, it may be requested upon the fact that a user who uses the networked monitor designates the place for monitoring. Or, when the other networked camera captures the object due to the movement of the object, the object may notice to the networked monitor via the said networked camera, thereby making a request upon the said notice. If the connection request cannot be fulfilled in the step 2512, other cameras neighboring thereto are searched (2514). Herein, the neighboring means, not only on geography, but also includes a case where it has a relation therewith in a sense of information. For example, it may be a relation of a camera having high frequency of use by other networked monitors. In this case, the networked monitor can receive the images of the camera, continuously, which are referred much from the other networked monitors. Also, the steps 2513 and 2514 may be conducted at the same time. For example, when the image of a certain position is required from the networked monitor, and if the monitoring areas of the plural number of cameras overlap each other, it may be possible that, first search is made on the camera in vicinity in the step 2514, and then, the selection is made on the most suitable camera in the step 2512. In a case where the networked camera results to be connected with the networked camera other than the networked camera A, with those processes, the URL of the corresponding networked camera is transmitted to the networked monitor (2515). When receiving the neighboring camera information in the step 2501 for selecting the connection information, the networked monitor can select the networked camera to be connected next from a list of the networked cameras included in the neighboring camera information received. If there is one (1) networked camera included in the neighboring camera information, there is no necessity to make the selection. For example, in the case of the neighboring camera information, being constructed with a list of the information of the networked cameras including the position information therein, the networked monitor can select the networked monitor nearest from the position designated on the terminal of the networked monitor. After selecting the networked camera to be connected, the networked monitor transmits the connection request to the said networked camera (2502). In the present example, it is connected to the networked camera B. Upon receipt of the connection request (2521), the networked camera B determine a region of the request (2522). Hereinafter, it operates in the similar manner to that explained in the networked camera A.

However, in the present example, thought the index server is not used, but except for the case of selecting the connection information of the networked camera at first, but the index server may be used also when searching the neighboring cameras, or when selecting the connection information, etc. Also, the transmission of the connection request in the step 2502 should not be made every time, but the networked camera A may deliver the connection request directly to the networked camera to be connected next in the step 2515. In this case, after delivering the request of the image once, the networked monitor can distribute the images, in a manner of relaying between the networked cameras. In this case, the connection request may be a condition, such as, moving at a speed 40 Km per hour on a national road No. 1 from a starting point A, and so on, for example.

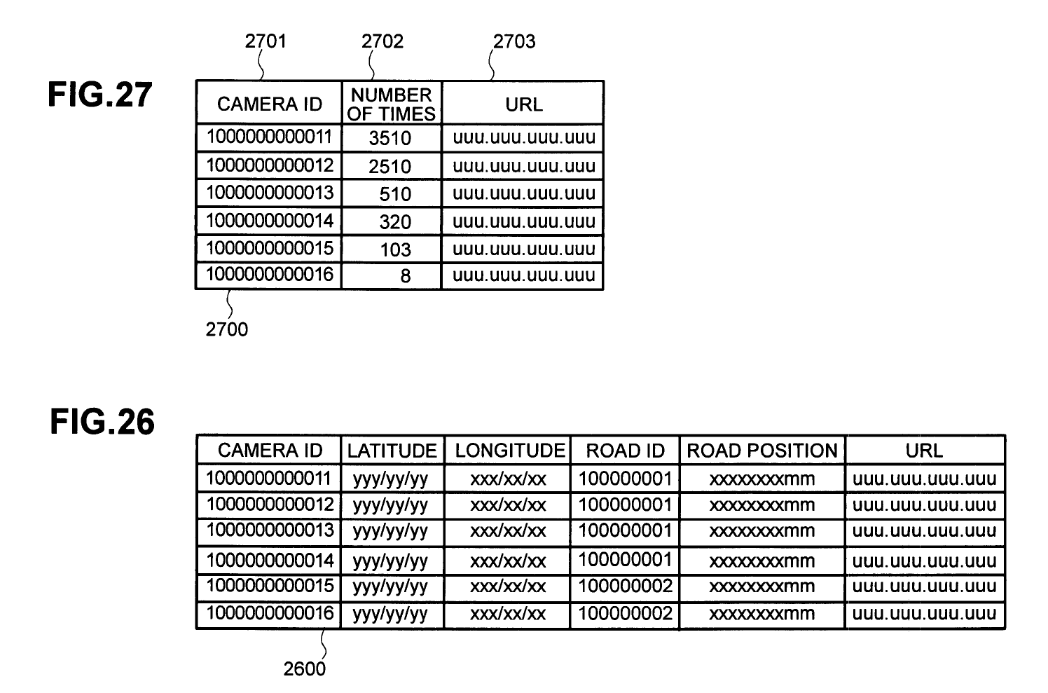

FIG. 26 shows an example of the information table, which is held in the neighboring information device. Those are same information, which are held by the index server. As a method for producing the present information table, the followings can be listed up: such as, the information of the vicinity thereof is collected with using the index server, so as to produce it; or it is produced by registering the information into either one or both of the terminals if a terminal lies in vicinity, while broadcasting the position information of itself, thereby to determine the terminal receiving thereof is in neighbor or not; or it may be produced by registering the terminal to be in neighbor, which can be connected directly with using an infrared ray communication or a short-range communication, etc.

FIG. 27 shows an example of an information table held in a neighbor information holder device. The present information table indicates, to which camera the networked monitor is connected, next, connecting to the networked camera holding the said neighbor information holder device. A reference numeral 2701 indicates a camera, which is connected next, 2702 times of being connected, and 2703 the URL. With those, it is possible to connect to the camera, which is connected in most commonly, easily.

With those embodiments mentioned above, the networked cameras can be set up easily, and it can be achieved by providing the index server. Further, with connecting the networked cameras and the networked monitors each other, but not via the index server, it is possible reduce the load of the server. Therefore, it is possible to provide the networked monitoring system and the monitoring method, being high in stability and immediacy, but without taking costs for the system construction, thereby enabling everyone to use easily.

The invention may be embodied in other specific forms without departing from the spirit or essential characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A networked camera system, comprising:
a plural number of networked cameras;
a networked monitor;
an index server; and
a network, wherein said cameras, said monitor and said server are connected, respectively, through said network, for monitoring a picture transmitted from said networked camera on said networked monitor, and wherein
each of said networked cameras comprises: a memory for memorizing networked camera information for discriminating the networked cameras, respectively; an image pickup element for picking up the picture; and a transmitter for transmitting said picture picked-up to said networked monitor upon receipt of a connection request from said networked monitor,
said index server comprises: a register for registering the networked camera information of each of said networked cameras; a search unit for searching connection information to the networked camera corresponding thereto, depending upon a monitoring object transmitted from said networked monitor, with using the networked camera information registered in said register; and a transmitter for transmitting said connection information searched to said networked monitor,
said networked monitor comprises: a transmitter for transmitting said monitoring object to said index server; a connection request unit for connecting to a predetermined networked camera and requesting the picture picked-up, upon basis of the connection information transmitted from said index server; and
a display for displaying the picture transmitted from said networked camera thereon, and
said networked camera and said networked monitor transmits the picture picked-up through connection to each other.

2. The networked camera system, as described in the claim 1, further comprising a storage, being connected through said network, wherein
said storage comprises a storage unit for storing monitor pictures transmitted from said networked camera, and a transmitter for transmitting said monitor picture upon a transmission request from said networked monitor.

3. The networked camera system, as described in the claim 1, wherein said networked camera information includes at least one of an ID of said networked camera, position information with using a latitude and a longitude, an ID of a road, on which said networked camera is provided, a distance from a reference point of the road, on which said networked camera is provided, and a network address of said networked camera.

4. The networked camera system, as described in the claim 1, wherein said register registers network address and position information of said networked camera relating therewith, when registering said networked camera information therein.

5. The networked camera system, as described in the claim 1, wherein said networked monitor comprises a controller for controlling destination of connection by said connection requesting unit.

6. The networked camera system, as described in the claim 5, wherein said networked camera has a detector for detecting an object as being a monitoring target, and said controller of said networked monitor controls, so as to receive the monitor picture from said networked camera picking-up the object, which is detected by said detector.

7. The networked camera system, as described in the claim 6, wherein said object comprises a unit to be detected by said detector.

8. The networked camera system, as described in the claim 7, wherein said detector of said networked camera is a sensor for generating radio waves, and said unit to be detected of said object comprises a unit for generating radio waves for response when detecting said radio wave.

9. The networked camera system, as described in the claim 8, wherein said detector receives latitude and longitude information from a system enabling measurement of the latitude and the longitude, and transmits said latitude and longitude information to said index server or said networked camera, thereby using it as a function of a sensor through detecting that it is within a region of the latitude and the longitude, which said network camera sets.

10. The networked camera system, as described in the claim 5, wherein said register registers an ID of said object and an ID of the networked camera, which captures said object on the sensor thereof.

11. The networked camera system, as described in the claim 1, wherein said networked monitor transmits said connection information to other networked monitor, and the other networked monitor makes a connection request to the networked camera having said connection information, to receive the monitor picture from said networked camera, thereby conducting exchanging control between said plural number of networked monitors.

12. The networked camera system, as described in the claim 1, wherein said networked monitor comprises a guidance display unit for displaying a guidance of mapping locations of said networked cameras on a map.

13. The networked camera system, as described in the claim 1, wherein networked monitor comprises an exchanger, and said exchanger exchanges destination of distribution of the monitor picture from said networked camera to other networked monitor.

14. The networked camera system, as described in the claim 1, further comprising an accounting unit for allowing said networked monitor to account onto said object, upon basis of fact that the object being the monitoring target concludes to enter into a contract to be monitored between said networked monitor.

15. The networked camera system, as described in the claim 2, wherein said storage is constructed to be located in said networked camera and said networked monitor dispersedly.

16. A networked camera system, comprising:
a plural number of networked cameras;
a networked monitor;
an index server; and
a network, wherein said cameras, said monitor and said server are connected, respectively, through said network, for monitoring a picture transmitted from said networked camera on said networked monitor, and wherein
each of said networked cameras has networked camera information for discriminating said networked cameras, respectively, and networked camera information of other networked camera, and comprises: an image pickup element for picking up the picture; a first search unit for searching connection information of requiring monitor from the networked camera information of said other networked camera upon receipt of a request of said networked monitor; and a transmitter for transmitting said picked-up monitor picture and the connection information searched out by means of said first search unit, to said networked monitor, upon receipt of a request from said networked monitor,
said index server comprises: a register for registering the networked camera information of each of said networked cameras; a second search unit for searching connection information to the networked camera corresponding to the request of said networked monitor from said networked camera information registered; and a transmitter for transmitting said connection information searched to said networked monitor,
said networked monitor comprises: a transmitter for transmitting said monitoring object to said index server; a connection request unit for connecting to a networked camera, to which a use requires monitoring, from the connection information transmitted from said index server or the connection information transmitted from said networked camera, thereby requesting a monitor picture thereto; a controller unit for controlling destination of connection by said connection request unit; and a display for displaying the monitor picture transmitted from said networked camera thereon, and
said networked camera and said networked monitor transmits the picture picked-up through connection to each other, and exchange to the networked camera requiring the monitoring is conducted by said first search unit and said transmitter of said networked camera.

17. The networked camera system as described in the claim 1, wherein said networked camera and said networked monitor conduct transmission of the monitor picture through mutual connection therebetween, without passing through the index server.

18. The networked camera system as described in the claim 16, wherein said networked camera and said networked monitor conduct transmission of the monitor picture through mutual connection therebetween, without passing through the index server.

19. The networked camera system as described in the claim 1, wherein said search unit calculates the monitoring target transmitted from said networked monitor, from the networked camera information registered in said register, thereby searching out the connection information from the calculation result.

20. A monitoring method comprising the following steps of:
a step for connecting a networked camera, having a unit for setting networked camera information and a unit for picking up a monitor picture therein, to a network;
a step for registering said networked camera information to an index server, which is connected to said network;
a step for designating a monitoring region desired to the networked monitor connected to said network;
a step for transmitting the monitoring region designated from said networked monitor to said index server;
a step for searching the networked camera information upon basis of said monitoring region received, from the networked camera information registered, in said index server;
a step for transmitting said networked camera information searched to said networked monitor;
a step for selecting the networked camera information of the networked camera, to which the monitoring is required, from the networked camera information received by said networked monitor;
a step for transmitting a connection request from said networked monitor to the networked camera having said networked camera information selected;
a step for transmitting the monitor picture, from the networked camera, on which said connection request is made, without passing through the index server, to the networked monitor connected to each other; and
a step for displaying the monitor picture received on said networked monitor.
